(19) United States
(12) Patent Application Publication
(10) Pub. No.: US 2009/0266855 A1
(43) Pub. Date: Oct. 29, 2009

(54) Vehicle Visor Band

(76) Inventor: Willard M. Stephens, Lithia Springs, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/416,450

(22) Filed: Apr. 1, 2009

Related U.S. Application Data
(60) Provisional application No. 61/041,426, filed on Apr. 1, 2008.

(51) Int. Cl. B60R 7/05

(52) U.S. Cl. 224/312

(57) ABSTRACT

A band assembly (10) is mounted to an automobile sun visor (12). The band assembly includes a flexible elastic band (20), a pair of rigid end tips (28, 30), a coupling (32), and a decal (33). The end tips are connected to opposed ends (24, 26) of the flexible elastic band. The coupling has two pairs of keepers (40, 42). The keepers extend from the back surface (38) of the coupling (32) and are supported by keeper support members (50). Openings are formed in the coupling (32) to correspond in location, size, and shape with the keepers. The keepers and keeper support members are positioned in relation with the back surface of the coupling to form a passageway. The passageway is such that the elastic band can pass through, but the end tips cannot. This configuration provides a means for engaging the end tips into the coupling to form a continuous band assembly for installation on the sun visor. The decal (33) is affixed to the face (36) of the coupling.

### CROSS REFERENCE TO RELATED APPLICATION

Applicant claims the benefit of U.S. Provisional Patent Application 61/041,426, filed in the U.S. Patent and Trademark Office on Apr. 1, 2008.

### FIELD OF THE INVENTION

This invention relates generally to a band for use on sun visors of automobiles (cars, trucks, etc.) More specifically, this invention relates to a band assembly for surrounding an automobile sun visor and other objects, for holding objects and displaying a logo or promotional decal.

### BACKGROUND OF THE INVENTION

People have expressed their allegiance to various teams, agencies, and organizations for many years. Today, sports teams at all levels, corporations, various charitable and non-charitable organizations, religious faiths and other products create a tremendous following. This following creates a desire for various novelty and useful items that provide these people with an outlet to express themselves regarding the teams, company, organization, or product to which they belong or support.

Virtually every automobile is manufactured with a pair of adjustable sun visors for shielding the light and glare from the sun during the day and occasionally the approaching headlight glare at night. The sun visors usually are mounted at the intersection of the headliner and the windshield, one just above the head of the driver and the other just above the head of the passenger. The sun visors are folded upwardly to be out of the line of sight and placed in a stored position when not being used and are folded downwardly to be placed in a working position when needed to block sun or lights. The sun visors usually are designed to swivel laterally when in the folded down, working position, so that the automobile driver or passenger can adjust his or her visor to deflect the direct sun light and glare away from their eyes in various directions.

Stretchable bands have previously been created which can be attached to a sun visor in order to keep various personal items stored between the band and the sun visor.

The concept of a band for retaining items has not been taken the step further to also provide a holder for a logo or decal for advertising or promoting a team, company, organization, faith or product. Therefore, this disclosure concerns a novelty item that would be used primarily as an elastic band that would be placed around the sun visor of an automobile for retaining objects and secondarily as a means for displaying loyalty to a team, company, organization, product or concept.

### SUMMARY OF THE INVENTION

Briefly described, the present invention comprises a band assembly for mounting about an automobile sun visor or the like and retaining objects such as maps, cards, and notes between the assembly and the visor. The band assembly includes a coupling and a flexible elastic band. The band includes a pair of enlarged end tips at the ends of the band. The coupling includes a decal holder for displaying a decal or logo. The elastic band is sized and shaped to encircle an automobile sun visor when used in conjunction with the coupling. By encircling the sun visor, objects can be retained by the band assembly on either side of the sun visor. One of the end tips is attached to one end of the band, and the other end tip to the other end of the band. The end tips provide a means for locking the band into the coupling and preventing fraying of the ends of the elastic band.

The coupling is constructed to receive the rigid end tips and the elastic band in a locking engagement to form a continuous loop band assembly for installation. To achieve this relationship, the coupling is formed with a pair of keepers. The keepers of the pair of keepers are spaced from each other a distance less than the breadth of the end tips. The keepers are supported by keeper support members extending from a back surface of the coupling. The keeper support members are spaced apart from each other a distance greater than the length of the end tips and greater than the width of the elastic band. Also, the keeper support members support the keepers at a distance greater than the thickness of the elastic band and less than the thickness of the end tips from the back surface of the coupling. This spaced relationship forms a passage between the keepers and the back surface of the coupling through which the elastic band may pass, but the end tips may not. This enables an engaging relationship between the elastic band and the coupling for installation of the band assembly to the sun visor.

A decal may be in the form of a circular patch that is affixed to the coupling. The decal is attached to the front side of the coupling. The decal may be an embroidered patch, a printed disk, a material label, or a part of the coupling formed by molding the decal in the coupling material, etc. Typically, the decal will display the logo of a team, company, organization, product, etc. Furthermore, the elastic band and the coupling can be manufactured in various color schemes to coordinate with or contrast with the colors of the decal. In use, the decal may be displayed to the occupants of the automobile when the sun visor is in the stored position and can be displayed to those outside the automobile when the visor is in the working position, or the band assembly can be repositioned to display the decal to the occupants of the automobile when the visor is in the working position and to hide the decal when the visor is in the stored position.

Further features and advantages of the present invention will become apparent upon reading the following specification when taken in conjunction with the accompanying drawings.

### BRIEF DESCRIPTION OF THE DRAWINGS

FIG. 1 is a front perspective view of the band assembly mounted on an automobile sun visor.

FIG. 2 is a back view of the coupling with the band ends connected to the coupling.

FIG. 3 is a side view of the coupling.

FIG. 4 is a tope view of the coupling.

FIG. 5 is an exploded partial front perspective view of the band assembly.

FIG. 6 is an exploded rear perspective view of the coupling, showing the band and the end tips aligned with the coupling.

FIG. 7 is a top view of a coupling having a dome-shaped surface and with the logo patch secured to the surface.

FIG. 8 is a top view of a coupling having a dome-shaped surface and with a logo patch connected at its rim to the surface.

### DETAILED DESCRIPTION

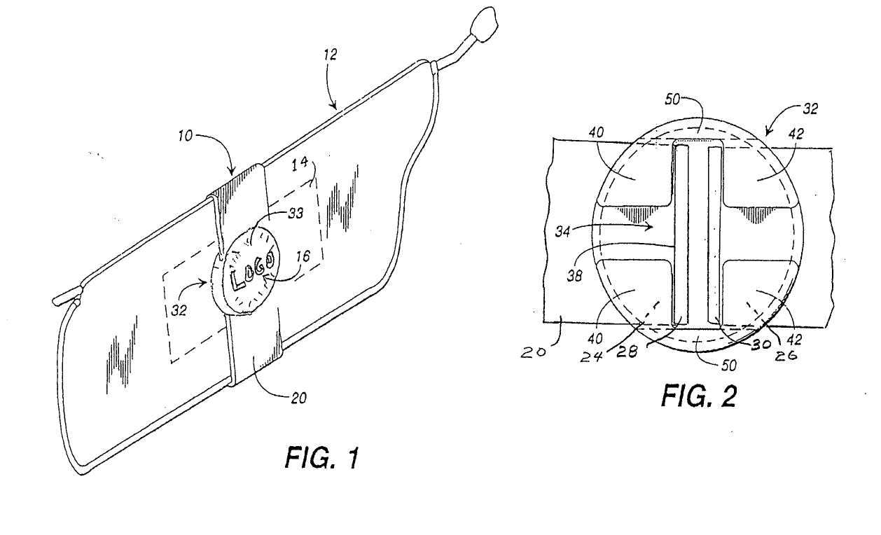

Referring now in more detail to the drawings in which like numerals indicate like parts throughout the several views, FIG. 1 illustrates the band assembly 10 mounted on a sun visor 12 such that the band assembly surrounds the sun visor. Once installed, the band assembly may hold objects 14, such as maps, insurance cards, tickets, notes, etc. securely between the band assembly and the sun visor. Since the band assembly completely circles the sun visor, objects may be retained on both sides of the sun visor, if desired. Although the band assembly is primarily designed for use in automobiles, the band assembly may also be used to bind to various other items such as books, notebooks, or to a person's leg or arm. The band assembly is constructed to display a logo 16. The logo may be that of a sports team, a corporation, an organization, or a product, to name a few.

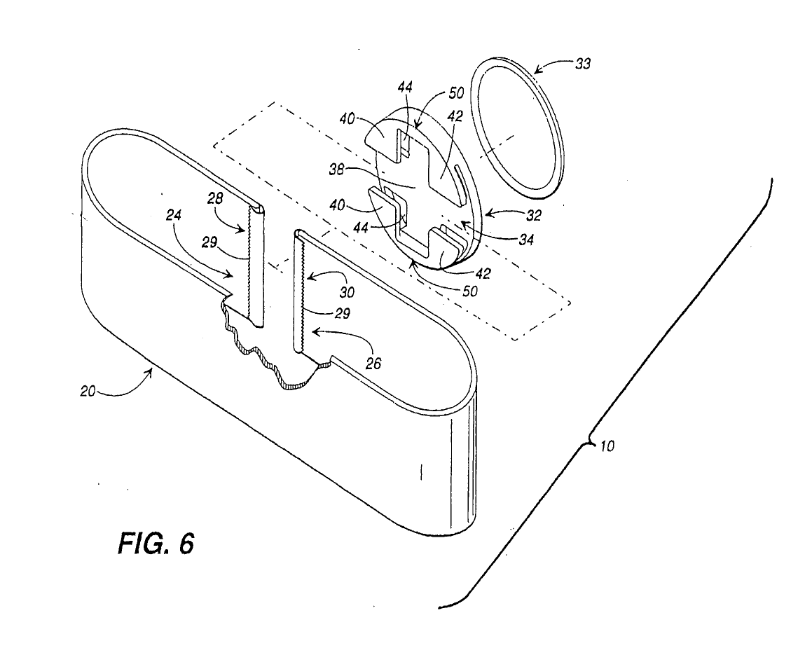

As shown in FIGS. 5 and 6, the band assembly 10 includes a flexible elastic band 20, a first enlarged end tip 28, a second enlarged end tip 30, a coupling 32, and a decal 33. The flexible elastic band is constructed with a first opposed end 24 and a second opposed end 26 defining the terminating ends of the elastic band. The elastic band preferably is constructed to be substantially flat and rectangular in shape. However, other shapes and configurations may be used. The length of the elastic band can vary but should be long enough to allow for easy installation, yet short enough to ensure a snug fit around the visor 12 or other object to which it is to be attached in order to securely retain objects 14 placed between the band assembly 10 and the visor. Ultimately, the length is dependent on the application for which it will be used; that is, the length can vary for use with various sized cars and trucks that have varying sizes of sun visors. The width of the elastic band can also vary depending upon the requirement or application.

The band 20 is made of an elastic material to enable easy installation over the sun visor 12 and easy placement of objects 14 between the band assembly 10 and the sun visor. The elastic band can be made of a variety of high quality elastic fiber materials, but the preferred material is a poly stretch material known for durability and long life stretch action. Also, the elastic band is dyed with a colorfast dye, heat treated, and dried. The color of the band may be determined by the logo 16 to be displayed by the band assembly. The color of the band is selected to coordinate or contrast with the color(s) of the logo.

First and second enlarged rigid end tips 28, 30 are attached to the opposed ends 24, 26, respectively, of the elastic band 20. The end tips are constructed having a U-shaped cross section. The parallel ends of the U each contain a plurality of teeth 29. During manufacture, the end tips are crimped onto the elastic band such that the teeth embed into the elastic band creating a semi-permanent construction (i.e., the end tips will separate from the elastic band only with significant prying of the teeth 28 and 29 out of the elastic band). The end tips preferably are made of brass with a lacquer sealer coating for protection; however, it would be apparent to construct the end tips without the coating or of other materials, such as plastic.

The function of the rigid end tips 28, 30 is twofold. First, the rigid end tips enable a locking engagement between the elastic band 20 and the coupling 32. This locking engagement creates a continuous loop construction of the band assembly 10 which provides for complete surrounding of the sun visor 12 when in use. The rigid end tips can be secured in the coupling and subsequently removed from the engagement for discontinuation of the loop of the band assembly. Second, the rigid end tips are used to prevent fraying of the opposed ends 24, 26 of the elastic band, thereby maintaining the original shape of the elastic band and an aesthetically pleasing appearance. While the end tips are depicted having a U-shaped cross section and teeth 29, it would be apparent to one skilled in the art to construct the end tips in various other fashions to achieve the same results. For example, one might use other cross section or teeth patterns, apply a coating to the opposed ends to prevent fraying and increase thickness, or heat the opposed ends to melt the material, thereby preventing fraying and increasing thickness.

Referring now to FIGS. 2-6, the coupling 32 has a body portion 34, a flat face 36, a flat back surface 38, two pairs of keepers 40, 42, openings 44 corresponding to the keepers, and a pair of keeper support members 50. The coupling is preferably constructed out of high impact, nonbreakable plastic for strength, durability, scratch resistance, low cost, and ease of manufacturability. It would be apparent to one skilled in the art to construct an equivalent coupling of a material other than plastic. The coupling may be solid in color. The color usually is chosen to coordinate or contrast with the logo 16 and the elastic band 20.

The body portion 34 of the coupling 32 is substantially a uniform thickness 46 (FIG. 4) to aid in the prevention of warping due to uneven cooling during manufacture. The two pairs of keepers 40, 42 are spaced from each other a distance less than the length of the end tips 28, 30 and less than the width of the elastic band 20. Openings 44 (FIGS. 5 and 6) are formed in the body portion to align with and correspond in size and shape with the keepers. Additionally, the openings are formed such that when the openings and the keepers are taken together, they comprise the thickness of the body portion. When the coupling is formed of plastic, the openings further provide for a simple mold design and for a smooth flow of material through the mold during manufacture.

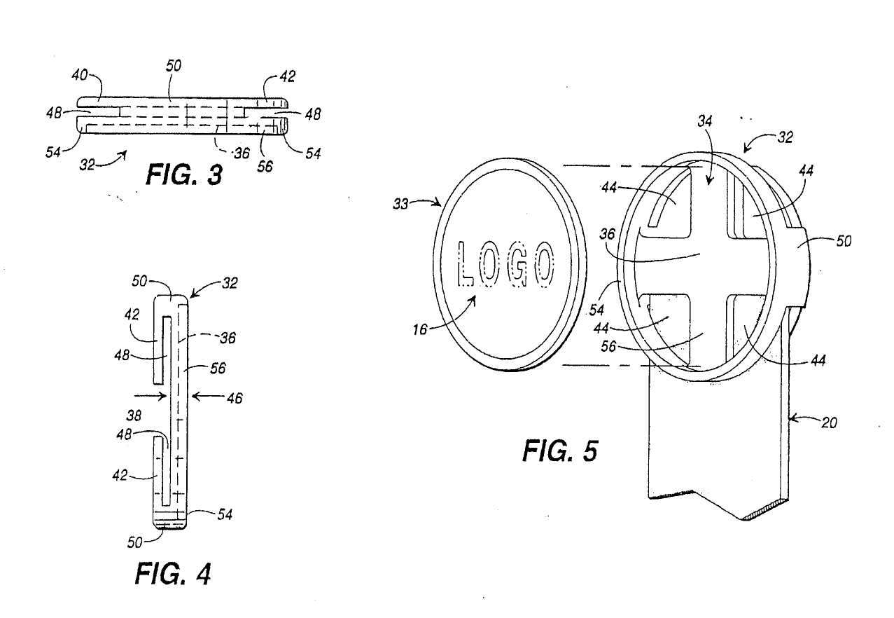

The pairs of keepers 40, 42 are supported by a pair of keeper support members 50. The keeper support members extend from the back surface 38 of the coupling 32 and are spaced from each other at a distance greater than the lengths of the end tips 28, 30 and greater than the width of the elastic band 20. The keeper support members support the keepers 40, 42 at a distance from the back surface of the coupling greater than the thickness of the elastic band and less than the thickness of the end tips. This spaced relationship defines a passage 48 (FIGS. 3 and 4) between the back surface and the keepers through which the elastic band may pass, but through which the end tips may not pass. Such configuration provides an engagement mechanism for connecting the elastic band and the coupling in a continuous loop for placement around the sun visor 12.

Referring now to FIG. 5, the flat face 36 of the coupling 32 receives the decal 33. The face may have a peripheral edge 54 and an indented area 56 within the peripheral edge. The indented area is sized and shaped to receive the decal therein.

The decal 33 contains the logo 16 to be displayed by the band assembly 10. The decal is sized and shaped to affix to the flat face 36 of the coupling 32. The decal is preferably adhesively attached to the face, but other attachment means may be utilized such as but not limited to tabs, tape or clips. The decal may be one of various types of common decals such as but not limited to an embroidered patch, a printed decal, soft materials and other materials suitable for this purpose. The color(s) and design(s) of the decal will be dependent on the logo to be displayed.

As shown in FIG. 1, when the band assembly is mounted on the sun visor, the decal is, at the option of the passenger(s) of the automobile, positioned to face the passengers, providing the image of the logo to the passenger(s) and providing a convenient location for storing maps and other relatively flat objects against the surface of the adjacent visor.

It will be noted that the configuration of the coupling allows one or more additional couplings to be mounted intermediate the ends of the band 20 by extending the band through the aligned openings 48 (FIG. 4) of the coupling, thereby providing decals 33 on both sides of the sun visor.

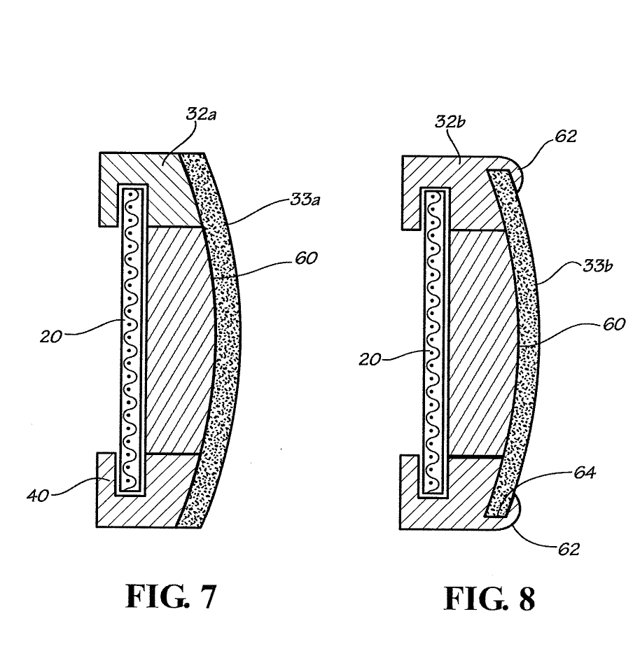

While the decal 33 of FIGS. 5 and 6 are substantially flat, disk-shaped for being received in the recess of the coupling, the decal can be of other shapes. For example, FIG. 7 shows a coupling 32A having a dome-shaped mounting surface 60 and a soft decal 33A adhesively mounted thereto. The decal may be made of various soft substances, including sponge, soft plastics, and rubber, among others. The softness of the decal 33A may be considered by some as a safety factor in case of impact. The decal 33A includes a circular perimeter that is coextensive with the circular rim of the coupling.

Another embodiment of the structure is shown in FIG. 8, in which the coupling 32B includes a perimeter rim 62 and a dome-shaped surface 60, with an inwardly facing recess 64 available to receive the perimeter of a circular decal, such as the flexible decal 33B.

Other shapes and attachment configurations may be used to mount the decals to the couplings of the invention.

It will be understood by those skilled in the art that while the foregoing description sets forth in detail preferred embodiments of the present invention, modifications, additions, and changes might be made thereto without departing from the spirit and scope of the invention, as set forth in the following claims.

1. A band assembly for surrounding an automobile sun visor, holding objects against the sun visor, and displaying a logo, comprising:
a flexible elastic band of predetermined thickness, width, and length and having first and second opposed ends;
first and second enlarged end tips each of a predetermined length fixedly attached to said first and second opposed ends respectively of said elastic band, said enlarged end tips each extending across substantially the full width of said band and each enlarged end tip being of a thickness greater than the thickness of said band;
a coupling fastened to said opposed ends of said band, said coupling including a body portion of uniform thickness having a substantially flat face and a substantially flat back surface opposed said face;
two pairs of keepers spaced from each other struck from said flat body portion of said coupling, said keepers of each pair of keepers being of a thickness substantially the same as the thickness of said body portion of said coupling and spaced from each other less than the lengths of said rigid end tips and less than the width of said band;
openings formed in said body portion aligned with and corresponding in size and shape with said keepers so that said body portion and said keepers together comprise only one thickness of said body portion;
keeper support members extending from said back surface of said coupling and spaced from each other a distance greater than the length of said end tips and the width of said band, said keeper support members supporting said keepers in spaced relationship with respect to said back surface of said body portion of said coupling a distance greater than said thickness of said band and less than the thickness of said end tips, said keepers of each pair of keepers defining a passage with respect to said back surface of said body portion for the passage there through of said band; and
a decal supported on said face of said coupling for displaying said logo;
whereby said tips are positioned between said first and second pairs of keepers and said band extends through said passages of said first and second pairs of keepers and said band and said coupling form said band assembly for surrounding the sun visor.

2. The band assembly of claim 1, wherein said first and second rigid end tips are made of metal.

3. The band assembly to claim 1, wherein said rigid end tips are made of plastic.

4. The band assembly of claim 1, wherein said decal is an embroidered patch.

5. The band assembly of claim 1, wherein said decal is printed.

6. The band assembly of claim 1, wherein said coupling is made of plastic.

7. The band assembly of claim 1, wherein said coupling face has a peripheral edge and an indented area within said peripheral edge sized and shaped to adhesively receive said decal therein of predetermined size.

8. The band assembly of claim 1, wherein said coupling is characterized by having been molded with two mold parts.

9. A visor band comprising:
a flexible elastic band having a thickness, width, length and having first and second opposed ends, each of a predetermined length, said first and second ends extending substantially the full width of said band and each being of a thickness greater than the thickness of said band;
a coupling fastened to said opposed ends of said band, said coupling including a body portion of uniform thickness having a substantially flat face and a substantially flat back surface opposed said face;
two pairs of keepers spaced from each other struck from said flat body portion of said coupling, said keepers of each pair of keepers being of a thickness substantially the same as the thickness of said body portion of said coupling and spaced from each other less than the length of said opposed ends and less than the width of said band;
openings formed in said body portion aligned with and corresponding in size and shape with said keepers so that said body portion and said keepers together comprise only one thickness of said body portion; and
keeper support members extending from said back surface of said coupling and spaced from each other a distance greater than the length of said opposed ends and the width of said band, said keeper support members supporting said keepers in spaced relationship with respect to said back surface of said body portion of said coupling a distance greater than said thickness of said band and less than the thickness of said opposed ends, said keepers of each pair of keepers defining a passage with respect to said back surface of said body portion for the passage therethrough of said band;
whereby said opposed ends are positioned between said first and second pairs of keepers and said band extends through said passages of said first and second pairs of keepers and said band and said coupling form said visor band.

10. The visor band of claim 9, wherein said first and second opposed ends include first and second rigid end tips fixedly attached to said first and second opposed ends respectively of said elastic band, said rigid end tips each extending across substantially the full width of said band and each being of a thickness greater than the thickness of said band.

11. The band assembly of claim 10, wherein said first and second rigid end tips are made of metal.

12. The band assembly of claim 10, wherein said first and second rigid end tips are made of plastic.

13. The visor band of claim 9, further comprising a decal supported on said face of said coupling.

14. The visor band of claim 13, wherein said coupling face has a peripheral edge and an indented area within said peripheral edge sized and shaped to adhesively receive said decal therein.

15. The band assembly of claim 13, wherein said decal is an embroidered patch.

16. The band assembly of claim 13, wherein said decal is printed.

17. The band assembly of claim 9, wherein said coupling is made of plastic.

18. The band assembly of claim 9, wherein said coupling is molded.
